(19) United States
(12) Patent Application Publication
(10) Pub. No.: US 2011/0243687 A1
(43) Pub. Date: Oct. 6, 2011

(54) SPECIAL-SHAPED RIVETING PIN FOR STEPLESS SPEED CHANGE CLUTCH

(75) Inventor: SHENG-KU HUANG, KAOHSIUNG (TW)

(73) Assignee: HUNG LI TECHNOLOGY CORP., KAOHSIUNG COUNTY (TW)

(21) Appl. No.: 12/753,404

(22) Filed: Apr. 2, 2010

(51) Int. Cl. F16B 19/04

(52) U.S. Cl. 411/501

(57) ABSTRACT

A special-shaped riveting pin for a stepless speed change clutch includes a transmission plate and actuating blocks, which are firmly combined together by the special-shaped riveting pin. The transmission plate is bored with a non-round riveting hole while the special-shaped riveting pin is formed with a non-round riveting portion to be correspondingly riveted with the non-round riveting hole. Thus, the actuating blocks and the transmission plate can firmly combined together for reinforcing the riveting pin so that the stepless speed change clutch can be used for a vehicle engine that outputs comparatively large torsion.

### BACKGROUND OF THE INVENTION

1. Field of the Invention

This invention relates to a special-shaped riveting pin for a stepless speed change clutch, particularly to one able to be firmly riveted with a transmission plate and secured between the transmission plate and actuating blocks (meaning centrifugal horse shoes) for stably combining the actuating blocks together with the transmission plate. Thus, when the actuating blocks are enlarged to increase weight, a stepless speed changer can be used for a vehicle engine that outputs comparatively large torsion, able to reinforce the structural strength of the stepless speed changer.

2. Description of Prior Art

A conventional clutch, as shown in FIGS. 1, 2 and 3, includes a transmission plate 1 having an inner side provided with actuating block (also called as a centrifugal horse shoe). The transmission plate 1 and the actuating blocks 2 are combined together by means of a riveting pin 3 that is formed with a round riveting portion 30 to be combined with a round riveting hole 10 of the transmission plate 1 and riveted together. Although the transmission plate 1 and the actuating block 2 can be combined together by the riveting pin 3, yet their combination is by mutual engagement of the round riveting portion 30 and the round riveting hole 10 that are apt to be loosened to turn around. Thus, when the actuating block 2 is to be enlarged to increase its weight for enhancing the torsion of an engine, the problem of weak combination strength between the around riveting pin 3 and the round riveting hole 10 may happen. To solve such a problem, a brazing device is provided to carry out brazing work for reinforcing the combination strength of the riveting pin 3 and the riveting hole 10, thus increasing cost and decreasing economic gain.

### SUMMARY OF THE INVENTION

The objective of this invention is to offer a special-shaped riveting pin for a stepless speed change clutch, able to be used for a vehicle engine that outputs comparatively large torsion, preventing trouble and avoiding being broken.

The special-shaped riveting pin for a stepless speed change clutch in the present invention includes a transmission plate and plural actuating blocks, which are combined together by the special-shaped riveting pin firmly fixed with the riveting hole of the transmission plate. The special-shaped riveting pin of this invention can be used for a vehicle engine that outputs comparatively large torsion, able to be kept tight enough not to loosen off or to be broken, reducing trouble and prolonging service life of the stepless speed change clutch, and lowering cost.

### BRIEF DESCRIPTION OF DRAWINGS

This invention will be better understood by referring to the accompanying drawings, wherein:

FIG. 1 is a partial cross-sectional view of a conventional clutch;

FIG. 2 is a partial magnified view of FIG. 1;

FIG. 3 is a side view of a conventional riveting pin;

FIG. 4 is a partial cross-sectional view of a riveting pin for a stepless speed change clutch in the present invention;

FIG. 5 is a cross-sectional view of the riveting pin for a stepless speed change clutch in use in the present invention;

FIG. 6 is a cross-sectional view of a transmission plate in the present invention;

FIG. 7 is a side view of a special-shaped riveting pin in the present invention;

FIG. 8 is a front view of the special-shaped riveting pin in the present invention;

FIG. 9 is a cross-sectional view of the special riveting pin combined with the riveting hole of a transmission plate in the present invention;

FIG. 10A is a schematic view of a first preferred embodiment of a special-shaped pin in the present invention;

FIG. 10B is a schematic view of a second preferred embodiment of a special-shaped riveting pin in the present invention; and

FIG. 10C is a schematic view of a third preferred embodiment of a special-shaped riveting pin in the present invention.

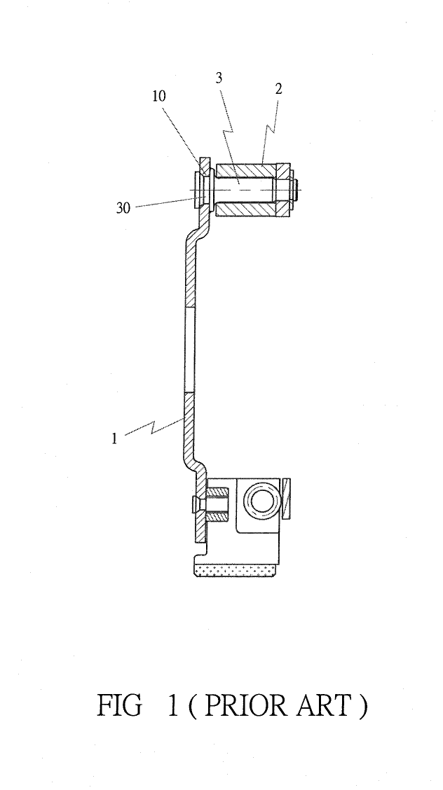

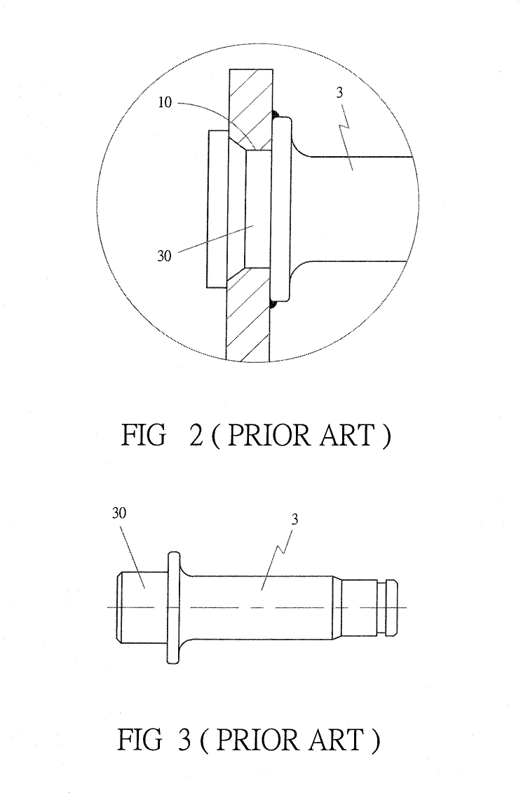

### DETAILED DESCRIPTION OF THE PREFERRED EMBODIMENT

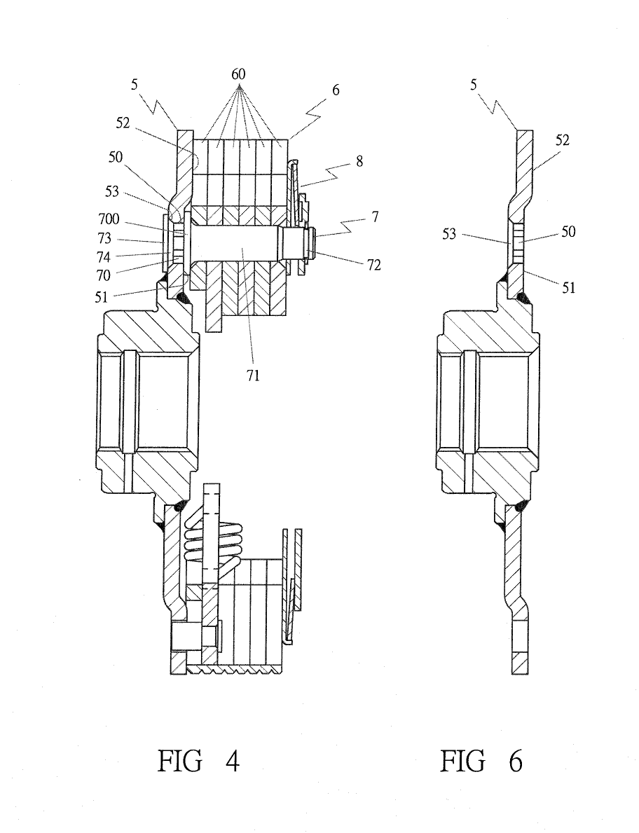

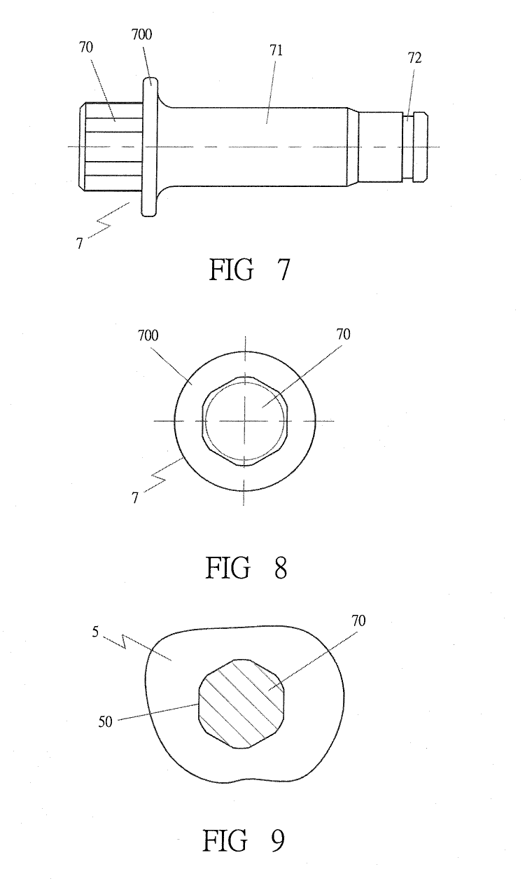

A preferred embodiment of a special-shaped riveting pin for a stepless speed change clutch in the present invention, as shown in FIGS. 4-7, includes a clutch casing 4, a transmission plate 5, plural actuating blocks 6 and a special-shaped riveting pin 7 combined together.

The clutch casing 4 is employed for receiving all the members mentioned below.

The transmission plate 5 is firmly assembled at one side of a fixed shaft, as shown in FIGS. 4-6, and formed with a non-round riveting hole 50 having its inner circumference provided with a recess 51 having its outer side formed with a slightly inward flat surface 52 and the riveting hole 50 having its outer side disposed with a V-shaped annular section 53.

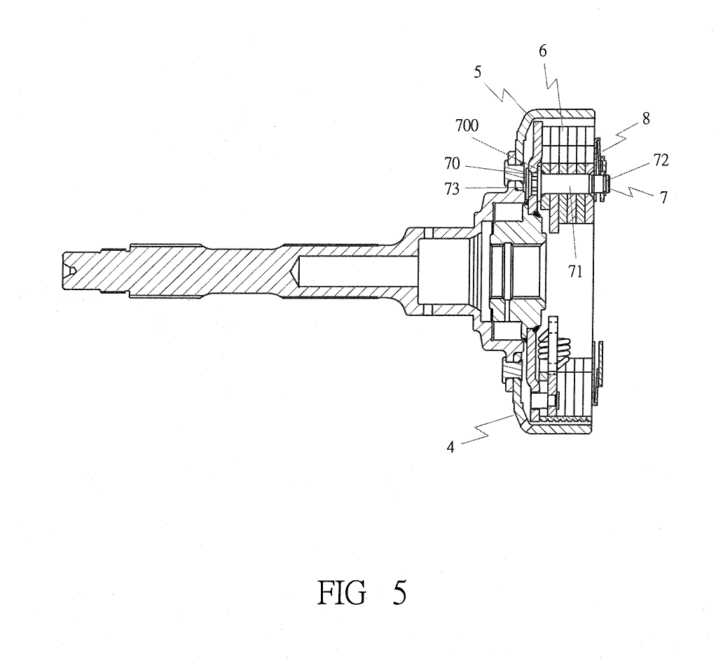

The actuating blocks 6 are respectively composed of a plurality of members 60, as shown in FIGS. 4 and 5, or of one single member.

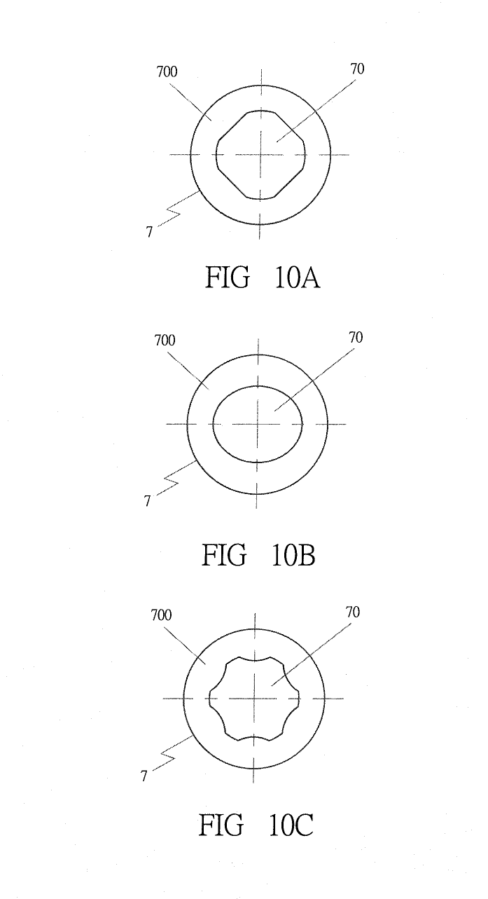

The special-shaped riveting pin 7, as shown in FIGS. 4, 7 and 8, is provided with a riveting portion 70 with a non-round shape. The so-called non-round shape means any geometric shape except a round shape, such as a square-like shape shown in FIG. 10A, an oval shown in FIG. 10B or a plum-blossom shape shown in FIG. 10C. Such a non-round shaped riveting portion 70 is to be symmetrically riveted with foresaid riveting hole 50 of the transmission plate 5. The riveting portion 70 is disposed with a separating annular section 700 for separating the riveting portion 70 from the shank 71 of the special-shaped riveting pin 7. The shank 71 of the special-shaped riveting pin 7 is for the actuating blocks 6 to be positioned thereon, and formed with a recessed annular section 72 so that a pressing member 8 can be fixed in the recessed annular section 72 for compressing the actuating blocks 6 to one side to let the actuating block 6 closely resisting against the flat surface 52 of the transmission plate 5 and secured therebetween, as shown in FIGS. 4 and 5.

In assembling, as shown in FIGS. 4 and 5, firstly, the special-shaped riveting pin 7 has its riveting portion 70 engaged in and combined with the riveting hole 50 of the transmission plate 5. After having the separating annular section 700 of the special-shaped riveting pin 7 resisting against the recess 51 of the transmission plate 5, the riveting portion 70 is riveted with the riveting hole 50 to form a riveted surface 73 whose inner side will be formed with a V-shaped wall surface 74 to match with the V-shaped annular section 53 of the transmission plate 5 and thus, the transmission plate 5 and the special-shaped riveting pin 7 can be combined together. After the transmission plate 5 is firmly clamped by the riveted surface 73 and the separating annular section 700 of the special-shaped riveting pin 7, the actuating blocks 6 are fitted on the special-shaped riveting pin 7, and then the pressing member 8 is secured at the outer side of the special-shaped riveting pin 7, thus able to combine the transmission plate 5, the actuating blocks 6 together with the special-shaped riveting pin 7 and the pressing member 8, as shown in FIGS. 4 and 5. By so designing, even if an engine is enlarged to enhance its torsion, the special-shaped riveting pin 7 will not become loosened to fall off or broken, enabling a stepless speed change clutch to be adapted to the enhancement of an engine horsepower, increasing value of the product, and reducing trouble and avoiding damage to a stepless speed change clutch.

While the preferred embodiment of the invention have been described above, it will be recognized and understood that various modifications may be made therein and the appended claims are intended to cover all the modifications that may fall within the spirit and scope of the invention.

I claim:

1. A special-shaped riveting pin for a stepless speed change clutch comprising:
a transmission plate bored with a non-round riveting hole having an inner circumference provided with a recess, said recess having an outer side formed with a slightly inward flat surface, said riveting hole having an outer side disposed with a V-shaped annular section;
plural actuating blocks;
a special-shaped riveting pin provided with a non-round riveting portion to be symmetrically combined with said non-round riveting hole, said riveting portion formed with a separating annular section to separate said riveting portion from a shank of said special-shaped riveting pin, said shank of said special-shaped riveting pin receiving said actuating blocks thereon, said shank disposed with a recessed annular section near an end for a pressing member to be fixed therein; and
said riveting portion of said special-shaped riveting pin engaged in said riveting hole of said transmission plate, letting said separating annular section resist against said recess of said transmission plate, a riveted surface formed after said riveting portion and said riveting hole are riveted together, said transmission plate firmly clamped by said riveted surface and said separating annular section.

2. A special-shaped riveting pin for a stepless speed change clutch as claimed in claim 1, wherein said riveting hole of said transmission plate can be of any geometric shape exclusive of a round shape, such as a square-like shape, an oval or a plum-blossom shape.

3. A special-shaped riveting pin for a stepless speed change clutch as claimed in claim 1, wherein said actuating blocks are respectively composed of plural members or of one single member.

4. A special-shaped riveting pin for a stepless speed change clutch as claimed in claim 1, wherein said riveting portion of said special-shaped riveting pin is of any geometric shape except a round shape, such as a square-like shape, an oval or a plum-blossom shape.

5. A special-shaped riveting pin for a stepless speed change clutch as claimed in claim 1, wherein a V-shaped wall surface is formed to match with said V-shaped annular section at an outer side of said riveting hole after said special-shaped riveting pin is riveted together with said riveting hole of said transmission plate.
